(19) United States
(12) Patent Application Publication
(10) Pub. No.: US 2025/0174448 A1
(43) Pub. Date: May 29, 2025

(54) MASS SPECTROMETER AND WAVE-DETECTION UNIT

(71) Applicant: SHIMADZU CORPORATION, Kyoto-shi (JP)

(72) Inventors: Shiro MIZUTANI, Kyoto-shi (JP); Toshihiro AKIYAMA, Kyoto-shi (JP)

(21) Appl. No.: 18/701,706

(22) PCT Filed: Oct. 18, 2021
(86) PCT No.: PCT/JP2021/038449

§ 371 Date: Feb. 18, 2025

(51) Int. Cl. H01J 49/02; H01J 49/42

(52) U.S. Cl. CPC H01J 49/025; H01J 49/4215

(57) ABSTRACT

A mass spectrometer includes a mass filter, a wave-detection unit and a power supply device. The mass filter selects ions having a mass-to-charge ratio corresponding to an applied AC voltage. The wave-detection unit detects an AC voltage to be applied to the mass filter. The power supply device applies an AC voltage to the mass filter based on an AC voltage detected by the wave-detection unit. The wave-detection unit has a plurality of rectifiers. Each of the plurality of rectifiers includes a rectifying device. The plurality of rectifiers are electrically connected to one another in parallel.

### TECHNICAL FIELD

The present invention relates to a mass spectrometer and a wave-detection unit.

### BACKGROUND ART

A mass spectrometer is known as an analysis device that analyzes the mass of a component included in a sample. For example, in a quadrupole mass spectrometer described in Patent Document 1, various ions generated from a sample by an ion source are introduced into a quadrupole filter. A high-frequency voltage and a DC voltage are applied to four rod electrodes of the quadrupole filter by a quadrupole power supply. Only ions having a particular mass-to-charge ratio selectively pass through the quadrupole filter and are detected by the detector. The mass-to-charge ratio of ions passing through the quadrupole filter depends on a high-frequency voltage and a DC voltage applied to each rod electrode.

In the quadrupole power supply, a high-frequency voltage applied to each rod electrode is converted into a wave-detection current through a capacitor, and the wave-detection current flows through a diode of a wave detector. The wave-detection current is converted into a DC voltage by flowing through a resistor, and the difference between the converted voltage and a target voltage is fed back. The target voltage is set in correspondence with any mass-to-charge ratio. Therefore, it is possible to sweep a high-frequency voltage applied to each rod electrode and scan the mass-to-charge ratio of ions passing through the quadrupole filter by sweeping a target voltage.
[Patent Document 1] JP 2002-033075 A
[Patent Document 2] JP 5556890 B2

### SUMMARY OF INVENTION

### Technical Problem

In a case in which a relatively large wave-detection current flows through a diode, a wave-detection voltage is converted into a voltage smaller than a voltage into which the wave-detection voltage is to be originally converted due to a leakage current in the diode, and an output voltage is larger than a target voltage in a feedback circuit. In this case, since the difference between the output voltage and the target voltage is increased in a large range of mass-to-charge ratio, a deviation in mass-to-charge ratio is generated.

Further, a DC voltage is controlled such that the ratio of the DC voltage to a high-frequency voltage is constant when the high-frequency voltage is swept. Here, a stable region in which ions can stably pass through a quadrupole filter (a stable region based on a stable condition of a solution of the Mathieu equation) is indicated by the substantially triangular frame of FIGS. 7(a) and 7(b) of Patent Document 2. As the mass-to-charge ratio is increased, the area of the stable region is increased while moving in the same direction as the direction in which the mass-to-charge ratio is increased.

The straight line representing a change in DC voltage with respect to the mass-to-charge ratio changes so as to cross the same portion of the stable region which similarly changes in correspondence with the mass-to-charge ratio. Therefore, it is possible to maintain mass resolution of the quadrupole filter in the overall range of mass-to-charge ratio. However, as described above, when a relatively large wave-detection current flows in a diode, the straight line representing a change in DC voltage does not cross a desired portion of the stable region in the large range of mass-to-charge ratio, and the uniformity of mass resolution is degraded.

An object of the present invention is to provide a mass spectrometer and a wave-detection unit that can prevent a mass deviation caused by non-linearity of a rectifying device.

### Solution to Problem

One aspect of the present invention relates to a mass spectrometer including a mass filter that selects ions having a mass-to-charge ratio corresponding to an applied AC voltage, a wave-detection unit that detects an AC voltage to be applied to the mass filter, and a power supply device that applies an AC voltage to the mass filter based on an AC voltage detected by the wave-detection unit, wherein the wave-detection unit has a plurality of rectifiers respectively including rectifying devices, and the plurality of rectifiers are electrically connected to one another in parallel.

Another aspect of the present invention relates to a wave-detection unit that detects an AC voltage to be applied to a mass filter that selects ions having a specific mass-to-charge ratio, having a plurality of rectifiers respectively including rectifying devices, wherein the plurality of rectifiers are electrically connected in parallel.

### Advantageous Effects of Invention

With the present invention, it is possible to easily prevent a mass deviation caused by non-linearity of a rectifying device.

### BRIEF DESCRIPTION OF THE DRAWINGS

FIG. 1 is a diagram showing the configuration of a mass spectrometer according to one embodiment of the present invention.

FIG. 2 is a diagram showing the configuration of a power supply device of FIG. 1.

FIG. 3 is a diagram showing the configuration of a wave-detection unit of FIG. 2.

FIG. 4 is a diagram showing the configuration of the wave-detection unit according to a comparative example 1.

FIG. 5 is a diagram showing the voltage measurement results with respect to wave-detection currents in the comparative example 1 and inventive examples 1 to 3.

FIG. 6 is a diagram showing a mass spectrum that is obtained in the measurement using a wave-detection unit according to the comparative example 1.

FIG. 7 is a diagram showing a mass spectrum that is obtained in the measurement using a wave-detection unit according to the inventive example 1

FIG. 8 is a diagram showing a mass spectrum that is obtained in the measurement using a wave-detection unit according to the inventive example 2.

FIG. 9 is a diagram showing a mass spectrum that is obtained in the measurement using a wave-detection unit according to the inventive example 3.

FIG. 10 is a diagram showing the relationship between a wave-detection current and a leakage current.

### DESCRIPTION OF EMBODIMENTS

### (1) Configuration of Mass Spectrometer

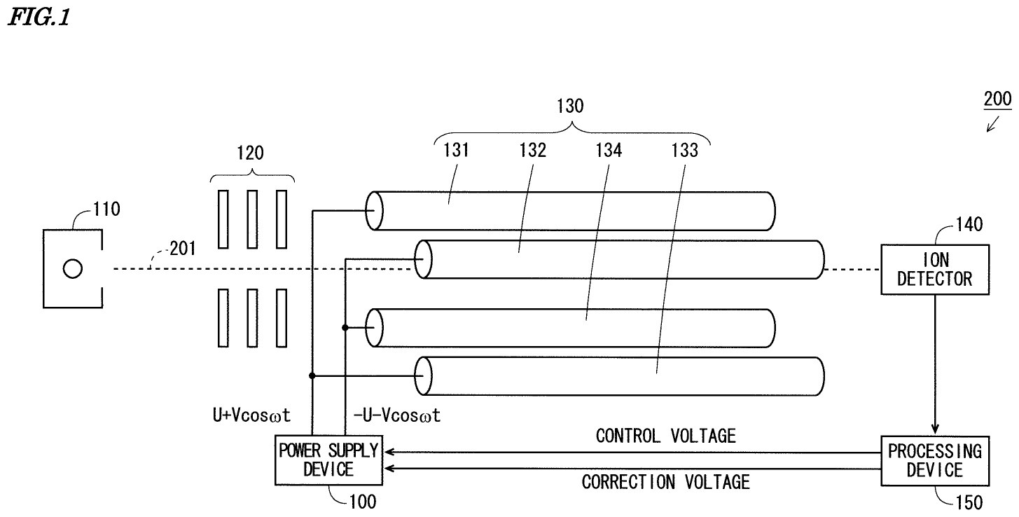

A mass spectrometer and a wave-detection unit including the mass spectrometer, according to embodiments of the present invention will be described below in detail with reference to the drawings. FIG. 1 is a diagram showing the configuration of a mass spectrometer according to one embodiment of the present invention. As shown in FIG. 1, the mass spectrometer 200 includes a power supply device 100, an ion source 110, an ion transporter 120, a quadrupole mass filter 130, an ion detector 140 and a processing device 150.

The ion source 110 includes a light source in an ultraviolet region, for example, and generates ions of various types of components included in a sample by irradiating a sample to be analyzed with pulsed light. The ion transporter 120 includes an ion lens, for example, and introduces ions generated by the ion source 110 into the quadrupole mass filter 130 along an ion optical axis 201 indicated by the dotted line while converging the ions.

The quadrupole mass filter 130 includes four rod electrodes 131 to 134. The rod electrodes 131 to 134 are arranged in parallel to one another so as to be inscribed in a virtual cylinder centered at the ion optical axis 201. Therefore, the rod electrode 131 and the rod electrode 133 are opposite to each other with the ion optical axis 201 therebetween. The rod electrode 132 and the rod electrode 134 are opposite to each other with the ion optical axis 201 therebetween.

The power supply device 100 applies a summed voltage (U+Vcosωt) which is obtained when a DC voltage U is added to a high-frequency voltage Vcosωt to the rod electrodes 131, 133. Further, the power supply device 100 applies a summed voltage (−U−Vcosωt) which is obtained when a DC voltage −U is added to a high-frequency voltage −Vcosωt to the rod electrodes 132, 134. Thus, among the ions introduced into the quadrupole mass filter 130, only the ions having a specific mass-to-charge ratio defined based on the DC voltage U and an amplitude V of the high-frequency voltage pass through the quadrupole mass filter 130. The configuration of the power supply device 100 will be described below.

The ion detector 140 includes a secondary electron multiplier, for example. The ion detector 140 detects the ions that have passed through the quadrupole mass filter 130 and outputs a detection signal indicating a detection amount to the processing device 150.

The processing device 150 includes a CPU (Central Processing Unit), for example, and is realized by an information processing apparatus such as a personal computer. The processing device 150 controls the operations of the power supply device 100, the ion transporter 120, the quadrupole mass filter 130 and the ion detector 140. Further, the processing device 150 processes a detection signal output by the ion detector 140 to generate a mass spectrum representing the relationship between a mass-to-charge ratio of ions and a detection amount.

### (2) Configuration of Power Supply Device

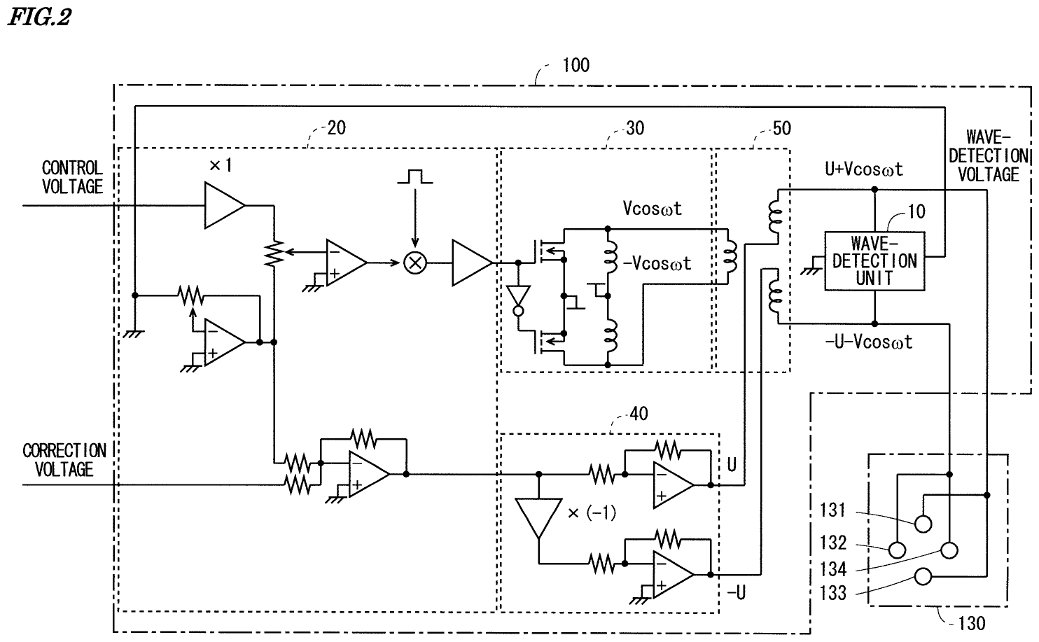

FIG. 2 is a diagram showing the configuration of the power supply device 100 of FIG. 1. As shown in FIG. 2, the power supply device 100 includes a wave-detection unit 10, a voltage controller 20, a high-frequency voltage generator 30, a DC voltage generator 40 and an adder 50. Each of the voltage controller 20, the high-frequency voltage generator 30 and the DC voltage generator 40 includes a circuit element such as an electrical resistor, a coil, a capacitor, an operational amplifier or a logic circuit. The adder 50 includes a transformer.

A control voltage and a correction voltage are supplied to the voltage controller 20 by the processing device 150 of FIG. 1, and a wave-detection voltage is fed back to the voltage controller 20 from the wave-detection unit 10. A control voltage is a voltage for controlling a high-frequency voltage to be applied to the quadrupole mass filter 130. A correction voltage is a voltage for correcting mass resolution of a mass-to-charge ratio. A wave-detection voltage to be fed back by the wave-detection unit 10 will be described below.

The voltage controller 20 suitably performs various processes such as comparison, modulation, amplification and addition on a control voltage, a correction voltage and a wave-detection voltage to generate voltages of two systems, and supplies the voltages to the high-frequency voltage generator 30 and the DC voltage generator 40. The high-frequency voltage generator 30 generates high-frequency voltages±Vcosωt having phases different from each other by 180° based on the voltage supplied by the voltage controller 20. The DC voltage generator 40 generates DC voltages±U having different polarities based on the voltage supplied by the voltage controller 20.

The adder 50 includes a transformer. The adder 50 adds the high-frequency voltages generated by the high-frequency voltage generator 30 to the DC voltages generated by the DC voltage generator 40, thereby generating a voltage U+Vcosωt and a voltage −U−Vcosωt. Further, the adder 50 adds the generated voltage U+Vcosωt from one output terminal of a secondary coil to the rod electrodes 131, 133 of the quadrupole mass filter 130. The adder 50 adds the generated voltage −U−Vcosωt from the other output terminal of the secondary coil to the rod electrodes 132, 134 of the quadrupole mass filter 130.

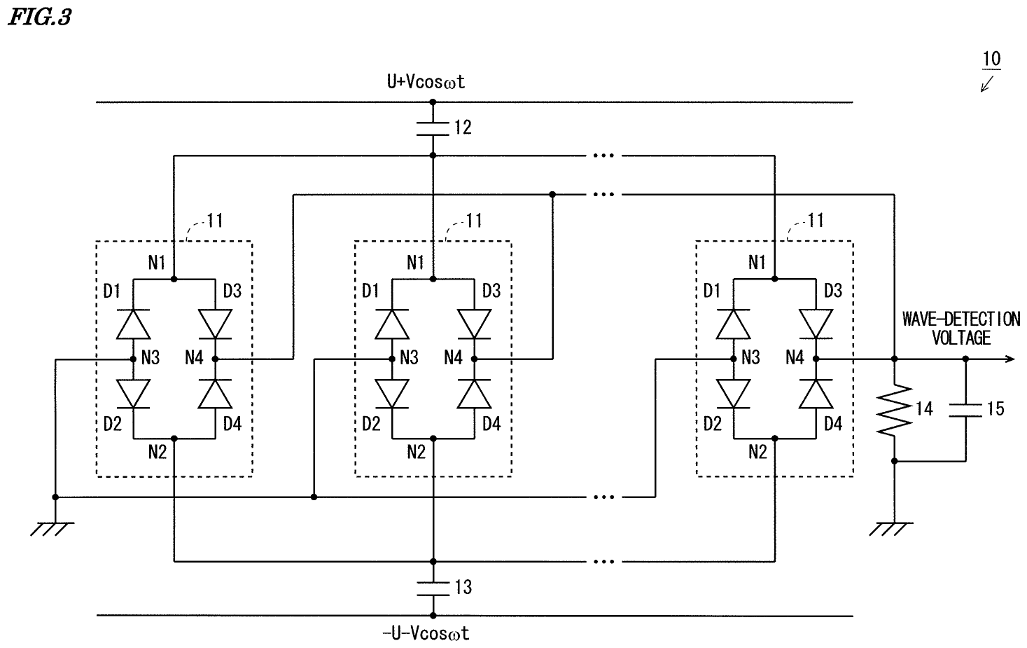

The wave-detection unit 10 is connected between the output terminals of the secondary coil of the adder 50, and converts a high-frequency voltage output from the adder 50 into a wave-detection voltage. FIG. 3 is a diagram showing the configuration of the wave-detection unit 10 of FIG. 2. As shown in FIG. 3, the wave-detection unit 10 includes a plurality of rectifiers 11, wave-detection capacitors 12, 13, a detection resistor 14 and a smoothing capacitor 15.

Each rectifier 11 includes four rectifying devices D1 to D4. The rectifying devices D1 to D4 are respectively high-speed diodes or Schottky barrier diodes, for example. A cathode and an anode of the rectifying device D1 are connected to nodes N1, N3, respectively. A cathode and an anode of the rectifying device D2 are connected to a node N2 and the node N3, respectively. A cathode and an anode of the rectifying device D3 are connected to a node N4 and the node N1, respectively. A cathode and an anode of the rectifying device D4 are connected to the nodes N4, N2, respectively.

The plurality of rectifiers 11 are connected in parallel to one another. Specifically, the nodes N1 of the plurality of rectifiers 11 are connected to one another, and the nodes N2 of the plurality of rectifiers 11 are connected to one another. Further, the nodes N3 of the plurality of rectifiers 11 are connected to one another, and the nodes N4 of the plurality of rectifiers 11 are connected to one another. The nodes N3 of the plurality of rectifiers 11 are connected to a ground terminal. As long as being equal to or larger than 2, the number 20 (count) of the rectifiers 11 provided in the wave-detection unit 10 is not limited in particular. The optimum number of the rectifiers 11 will be described below.

The wave-detection capacitors 12, 13 are ceramic capacitors, for example. The wave-detection capacitor 12 is connected between one output terminal of the adder 50 (FIG. 2) that outputs the voltage U+Vcosωt and the nodes N1 of the plurality of rectifiers 11. The wave-detection capacitor 13 is connected between the other output terminal of the adder 50 that outputs the voltage −U−Vcosωt and the nodes N2 of the plurality of rectifiers 11. The detection resistor 14 and the smoothing capacitor 15 are connected in parallel to each other and are connected to the nodes N4 of the plurality of rectifiers 11.

With the above-mentioned configuration, a high-frequency voltage of the output terminal of the adder 50 is converted into a wave-detection current by the wave-detection capacitor 12 or the wave-detection capacitor 13, and is rectified by flowing through the plurality of rectifiers 11. The rectified current flows through the detection resistor 14 to be converted into a wave-detection voltage and is fed back to the voltage controller 20 of FIG. 2.

### (3) Comparative Example and Inventive Examples

### (a) Voltage Deviation

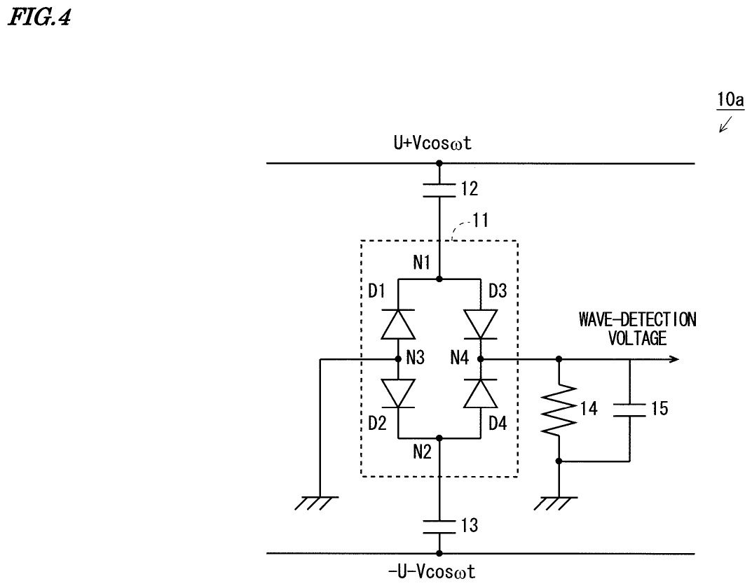

FIG. 4 is a diagram showing the configuration of a wave-detection unit according to a comparative example 1. As shown in FIG. 4, the wave-detection unit 10a according to the comparative example has the same configuration as that of the wave-detection unit 10 of FIG. 3 except that the wave-detection 10a includes one rectifier 11 instead of a plurality of rectifiers 11. A wave-detection unit 10 according to an inventive example 1 includes two rectifiers 11 connected in parallel to each other. A wave-detection unit 10 according to an inventive example 2 includes three rectifiers 11 connected in parallel to one another. A wave-detection unit 10 according to an inventive example 3 includes four rectifiers 11 connected in parallel to one another. The optimum number of the rectifiers 11 are considered using the wave-detection unit 10a according to the comparative example 1 and the wave-detection units 10 according to the inventive examples 1 to 3.

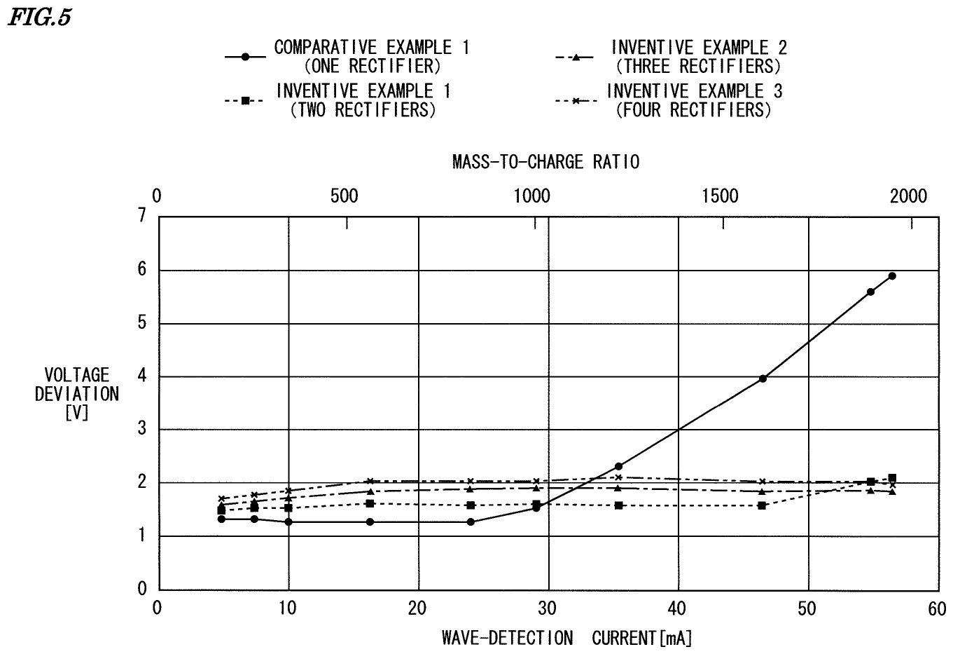

FIG. 5 is a diagram showing the voltage measurement results with respect to wave-detection currents in the comparative example 1 and the inventive examples 1 to 3. In FIG. 5, the abscissa indicates a wave-detection current (half amplitude), and the ordinate indicates a deviation of high-frequency voltage. Further, the abscissa of FIG. 5 also indicates a mass-to-charge ratio corresponding to a wave-detection current in the present example. A mass-to-charge ratio corresponding to a wave-detection current differs depending on the radius of a virtual cylinder in which the rod electrodes 131 to 134 are inscribed, the frequency of a high-frequency voltage, or the like.

As shown in FIG. 5, in the comparative example 1, the voltage deviation was increased in the range in which the wave-detection current was equal to or larger than 30 mA (corresponding to the range in which the mass-to-charge ratio was equal to or larger than about 1000). On the other hand, in the inventive examples 1 to 3, the voltage deviation was substantially constant in the range in which the wave-detection current was from 0 to 60 mA (corresponding to the range in which the mass-to-charge ratio was about 0 to 2000). Based on the results of FIG. 5, it was confirmed that, linearity of the rectifying devices D1 to D4 was improved by connection of the plurality of rectifiers in parallel to one another.

Further, the smaller the voltage deviation is, the smaller the minimum value (the target value) of the mass-to-charge ratio value can be. Here, the voltage deviation in the inventive example 2 was smaller than the voltage deviations in the inventive examples 3 and 4 in the range in which the wave-detection current was 0 to 45 mA (corresponding to the range in which the mass-to-charge ratio was about 0 to 1500). Therefore, it was confirmed that, in a case in which the wave-detection current was equal to or smaller than 45 mA, the optimum number of the rectifiers 11 was two.

On the other hand, the voltage deviation in the inventive example 2 was likely to increase slightly when the wave-detection current exceeded 45 mA. In contrast, the overall voltage deviation in the inventive example 3 was smaller than the voltage deviation in the inventive example 4 in the range in which the wave-detection current is from 0 to 60 mA. Therefore, it was confirmed that, in a case in which the wave-detection current was equal to or smaller than 60 mA, the optimum number of the rectifiers 11 was three.

### (b) Mass Spectrum

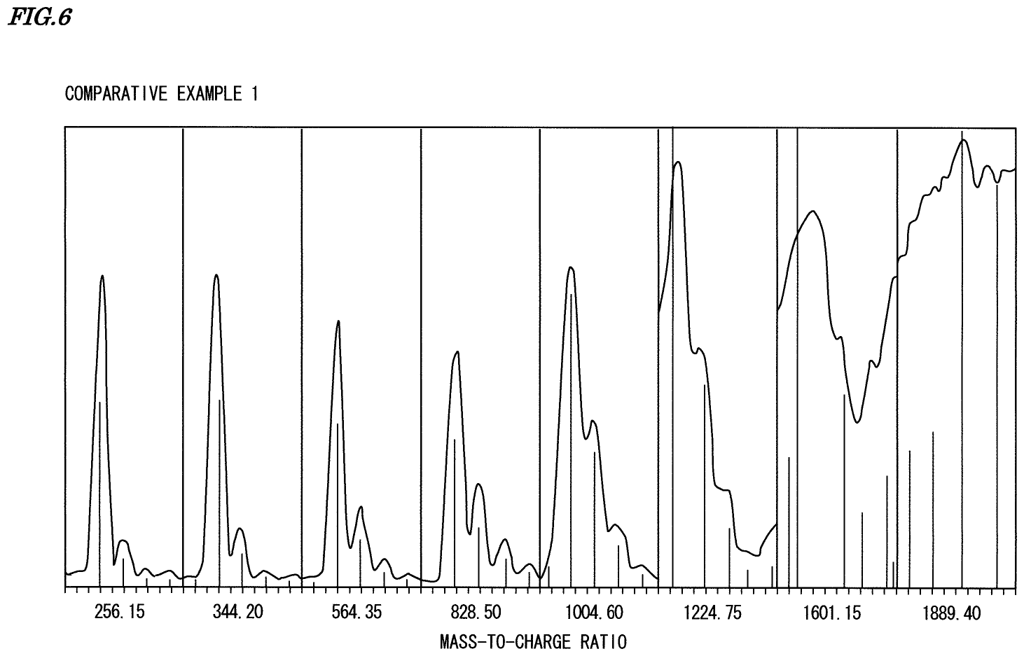

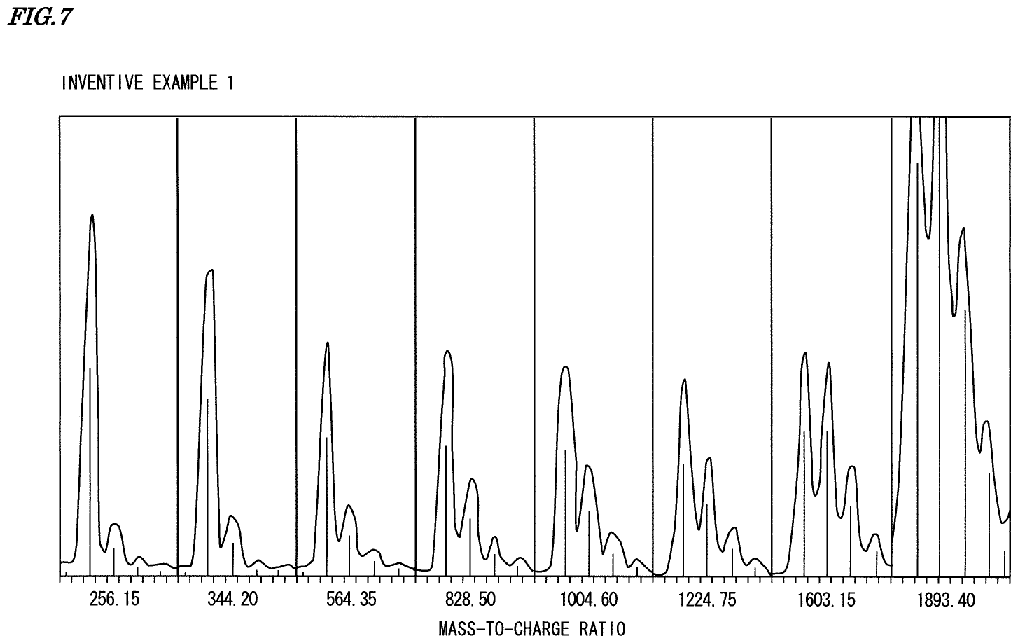

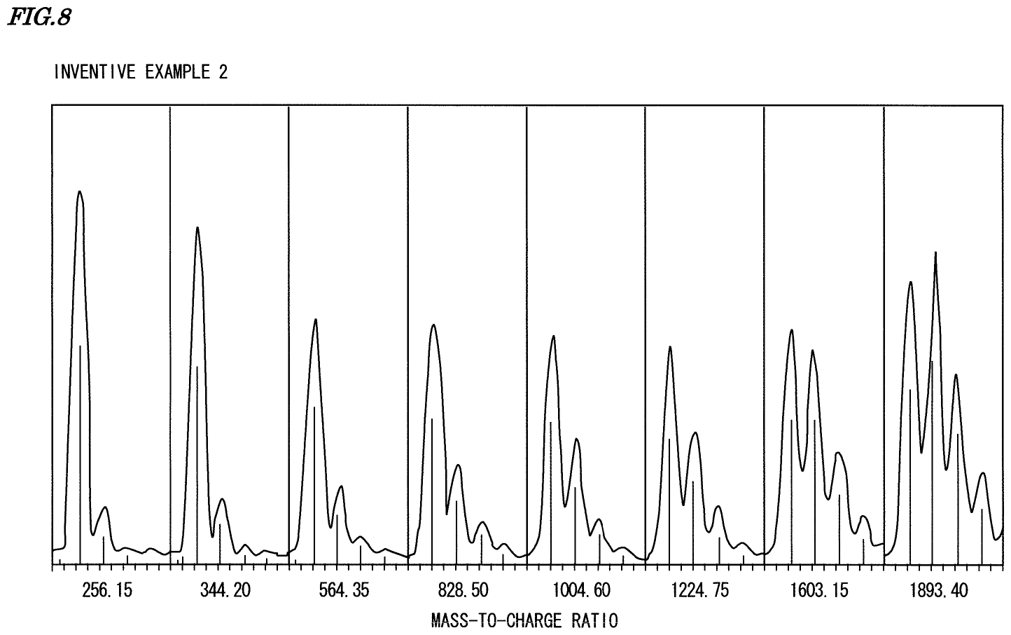

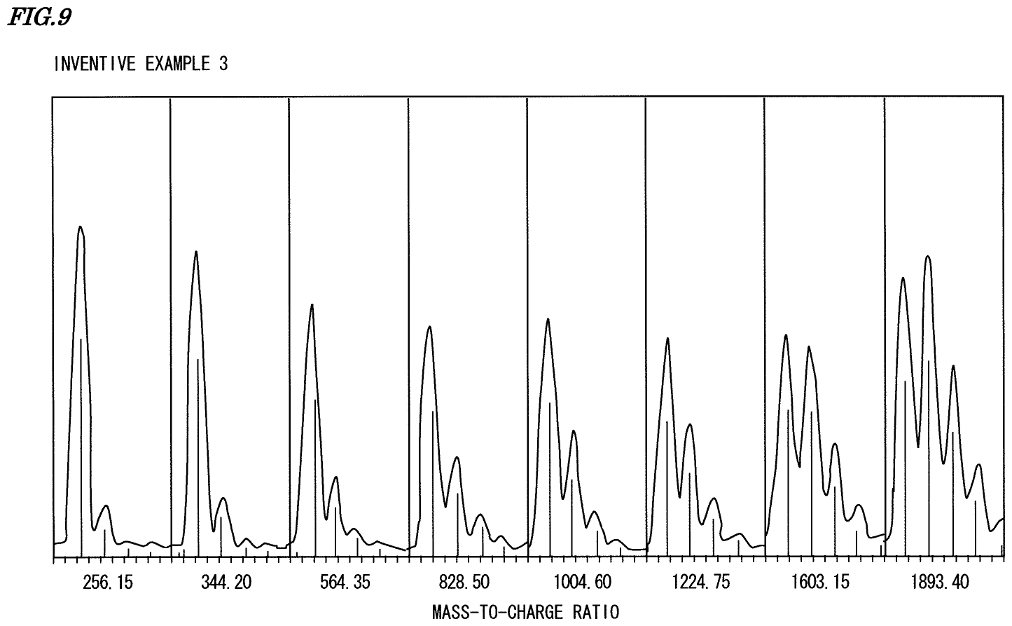

FIG. 6 is a diagram showing a mass spectrum that is obtained in the measurement using the wave-detection unit 10a according to the comparative example 1. FIG. 7 is a diagram showing a mass spectrum that is obtained in the measurement using the wave-detection unit 10 according to the inventive example 1. FIG. 8 is a diagram showing a mass spectrum that is obtained in the measurement using the wave-detection unit 10 according to the inventive example 2. FIG. 9 is a diagram showing a mass spectrum that is obtained in the measurement using the wave-detection unit 10 according to the inventive example 3. In each of FIGS. 6 to 9, peaks in the vicinity of a plurality of specific mass-to-charge ratios are displayed in a magnified manner. The magnification ratios for the plurality of peaks are different from one another.

In the comparative example 1, as shown in FIG. 6, the widths of peaks are increased in the range in which the mass-to-charge ratio is larger than 1004.60. Further, peaks in the vicinity of the mass-to-charge ratio of 1889.40 are not separated from other peaks. Although the widths of peaks in the vicinity of the mass-to-charge ratio of 1893.40 are increased in the inventive example 1 as shown in FIG. 7, each peak is separated from other peaks. In the inventive examples 2 and 3, as shown in FIGS. 8 and 9, the width of a peak is not increased, and each peak is separated from other peaks.

Based on the results of FIGS. 6 to 9, it was confirmed that each peak could be separated from other peaks even in a relatively large range of mass-to-charge ratio by connection of the plurality of rectifiers 11 in parallel. Further, a deviation of mass-to-charge ratio from a theoretical value in the inventive example 2 is smaller than a deviation of mass-to-charge ratio from a theoretical value in the inventive example 3. Therefore, it was confirmed that, it is possible to reduce a deviation of mass-to-charge ratio while preventing an increase in width of peak by setting the number of the rectifiers 11 connected in parallel to three.

### (c) Leakage Current

A current (leakage current) flowing in a direction opposite to the rectifying direction is generated in the rectifying devices D1 to D4. A leakage current includes a DC component generated when a reverse voltage is applied, an AC component generated due to the junction capacitance between an anode and a cathode and a component generated due to a reverse recovery time. It is considered that, the larger the leakage current, the larger the non-linearity of the rectifying devices D1 to D4. As a result, the larger the leakage current, the larger the voltage deviation. Further, the temperature characteristic of high-frequency voltage is degraded. As such, the leakage current of the rectifying devices D1 to D4 in the comparative example 1 and the inventive examples 1 to 3 are estimated.

An average current i flowing through the detection resistor 14 is provided by the following formula (1). Here, f is the frequency of high-frequency voltage (ω/2π) and is about 1.2 MHZ, for example. C is the capacitance of the wave-detection capacitors 12, 13, and is about 3 pF, for example. V is an amplitude (half amplitude) of the high-frequency voltage, and is about 2000 V to 3000 V at the maximum, for example. Strictly speaking, in the calculation of an average current i in the formula (1), a value obtained when a forward-direction voltage (about 0.6 V) of the rectifying devices D1 to 6V is subtracted from the above-mentioned value is used as the amplitude V of a high-frequency voltage.

$$[ Formula 1 ]$$

$$i = \frac{2}{π} \cdot 2 π fCV = 4 fCV \qquad ( 1 )$$

An average leakage current I flowing through the rectifying devices D1 to D4 is provided by the following formula (2). Here, vR is a voltage deviation when a predetermined high-frequency voltage is applied. Specifically, when the wave-detection current is 60 mA, it is estimated based on FIG. 5 that the voltage deviations vR in the comparative example 1 and the inventive examples 1 to 3 are 6 V, 2.1 V, 1.8 V and 2.0 V, respectively. 0.6 (V) in the formula (2) is a forward-direction voltage of the rectifying devices D1 to D4.

$$[ Formula 2 ]$$

$$I = i \cdot \frac{{v}_{R} - 0.6}{V} = 4 fC ( {v}_{R} - 0.6 ) \qquad ( 2 )$$

With the frequency of high-frequency voltage being 1.2 MHz and with the capacitance of the wave-detection capacitors 12, 13 being 3 pF, the leakage current I flowing through each of the rectifying devices D1 to D4 is estimated using the formula (2). As a result, in FIG. 5, the maximum leakage currents I in the comparative example 1 and the inventive examples 1 to 3 in FIG. 5 were 77.76 μA, 21.60 μA, 17.28 μA and 20.16 μA, respectively. Based on these results, it was confirmed that, in a case in which the wave-detection current is equal to or smaller than 60 mA (corresponding to the mass-to-charge ratio of about 2000 or less), it is possible to maintain the linearity of the leakage current in the rectifying device and make the leakage current flowing through the rectifying device at a minimum.

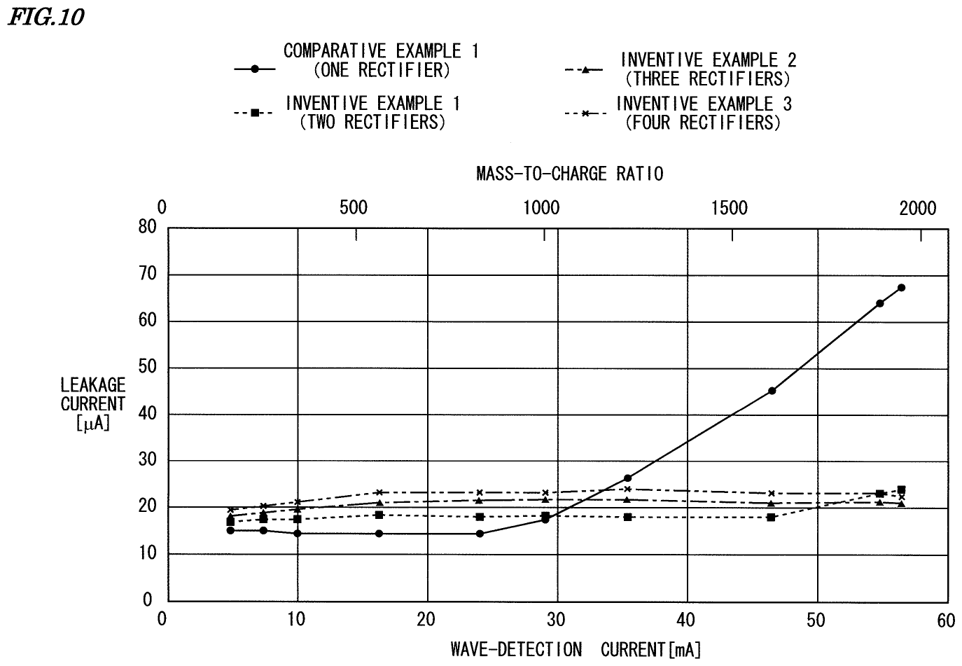

Based on similar examination, it is possible to estimate a leakage current with respect to a wave-detection current. FIG. 10 is a diagram showing the relationship between a wave-detection current and a leakage current. In FIG. 10, the abscissa indicates a wave-detection current (half amplitude), and the ordinate indicates an average leakage current. Further, the abscissa of FIG. 10 also indicates a mass-to-charge ratio corresponding to a wave-detection current. As shown in FIG. 10, in a case in which the wave-detection current is equal to or smaller than 45 mA (corresponding to the mass-to-charge ratio of about 1500 or less), it is possible to cause the rectifying device to show the linearity and make the leakage current flowing through the rectifying device at a minimum by making the number of rectifiers 11 connected in parallel be two.

### (4) Effects

In the mass spectrometer 200 according to the present embodiment, even in a case in which the linear operation range of the rectifying devices D1 to D4 of each rectifier 11 is not so wide, the overall linearity in the wave-detection unit 10 is improved by electrical connection of the plurality of rectifiers 11 to one another in parallel. Therefore, the mass resolution by the quadrupole mass filter 130 is uniform in the wide range of mass-to-charge ratio. Thus, it is possible to prevent a mass deviation caused by non-linearity of the rectifying devices D1 to D4.

The number of the rectifiers 11 in the wave-detection unit 10 is preferably defined such that a leakage current flowing through the rectifying devices maintains linearity in a specific range of mass-to-charge ratio. Thus, it is possible to easily prevent a mass deviation caused by non-linearity of the rectifying devices. Further, the number of the rectifiers 11 in the wave-detection unit 10 is preferably defined such that a leakage current flowing through the rectifying devices D1 to D4 is at a minimum. In this case, it is possible to more appropriately improve overall linearity in the wave-detection unit 10.

In the present embodiment, in a case in which the wave-detection current is 60 mA (corresponding to the mass-to-charge ratio of about 2000), three rectifiers 11 are electrically connected to one another in parallel. Thus, the overall linearity in the wave-detection unit 10 can be optimized in the range in which the mass-to-charge ratio corresponds to the wave-detection current equal to or smaller than 60 mA.

On the other hand, in a case in which the wave-detection current is 45 mA (corresponding to the mass-to-charge ratio of about 1500), two rectifiers 11 are electrically connected to each other in parallel. Thus, the overall linearity in the wave-detection unit 10 can be optimized in the range in which the mass-to-charge ratio corresponds to the wave-detection current equal to or smaller than 45 mA.

### (5) Other Embodiments

While the wave-detection unit 10 is provided in the power supply device 100 in the above-mentioned embodiment, the embodiment is not limited to this. The wave-detection unit 10 may be provided outside of the power supply device 100.

While the node N3 of each rectifier 11 is connected to the ground terminal and the node N4 of each rectifier 11 is connected to the detection resistor 14 and the smoothing capacitor 15 in the above-mentioned embodiment, the embodiment is not limited to this. The node N4 of each rectifier 11 may be connected to the ground terminal, and the node N3 of each rectifier 11 may be connected to the detection resistor 14 and the smoothing capacitor 15.

While the rectifier 11 includes the four rectifying devices D1 to D4 forming a full-wave rectifying circuit in the above-mentioned embodiment, the embodiment is not limited to this. The rectifier 11 may include one rectifying device forming a half-wave rectifying circuit.

### (6) Aspects

It is understood by those skilled in the art that the plurality of above-mentioned illustrative embodiments are specific examples of the below-mentioned aspects.

(Item 1) A mass spectrometer according to one aspect includes a mass filter that selects ions having a mass-to-charge ratio corresponding to an applied AC voltage, a wave-detection unit that detects an AC voltage to be applied to the mass filter, and a power supply device that applies an AC voltage to the mass filter based on an AC voltage detected by the wave-detection unit, wherein the wave-detection unit has a plurality of rectifiers respectively including rectifying devices, and the plurality of rectifiers are electrically connected to one another in parallel.

With the mass spectrometer, even in a case in which the linear operation range of a rectifying device of each rectifier is not so wide, overall linearity in the wave-detection unit is improved by electrical connection of the plurality of rectifiers to one another in parallel. Therefore, the mass resolution by the mass filter is uniform in the wide range of mass-to-charge ratio. Thus, it is possible to prevent a mass deviation caused by non-linearity of the rectifying devices.

(Item 2) The mass spectrometer according to item 1, wherein each of the plurality of rectifiers may include a first rectifying device, a second rectifying device, a third rectifying device and a fourth rectifying device, and includes a first node, a second node, a third node and a fourth node, and in each of the plurality of rectifiers, a cathode and an anode of the first rectifying device may be connected to the first node and the third node, respectively, a cathode and an anode of the second rectifying device may be connected to the second node and the third node, respectively, a cathode and an anode of the third rectifying device may be connected to the fourth node and the first node, respectively, a cathode and an anode of the fourth rectifying device may be connected to the fourth node and the first node, respectively, the first nodes of the plurality of rectifiers may be connected to one another and are used for input of an AC voltage to be applied to the mass filter, the second nodes of the plurality of rectifiers may be connected to one another and are used for input of an AC voltage to be applied to the mass filter, the third nodes of the plurality of rectifiers may be connected to one another, the fourth nodes of the plurality of rectifiers may be connected to one another, one of the third node and the fourth node may be maintained at a ground potential, and another one of the third node and the fourth node may be used for output of a detected AC voltage.

In this case, it is possible to improve overall linearity in the detection unit with a simple configuration.

(Item 3) The mass spectrometer according to item 1 or 2, wherein a count of the rectifiers in the wave-detection unit may be defined such that a leakage voltage flowing through the rectifying devices in a specific range of mass-to-charge ratio maintains linearity.

Thus, it is possible to easily prevent a mass deviation caused by non-linearity of the rectifying devices.

(Item 4) The mass spectrometer according to item 3, wherein a count of the rectifiers in the wave-detection unit may be defined such that a leakage voltage flowing through the rectifying devices are at a minimum.

In this case, it is possible to appropriately improve overall linearity in the detection unit.

(Item 5) The mass spectrometer according to any one of items 1 to 4, wherein the wave-detection unit may further include a wave-detection capacitor that converts an AC voltage to be applied to the mass filter into a wave-detection current and guides the wave-detection current to the plurality of rectifiers, the power supply device may apply an AC voltage corresponding to a wave-detection current having a half amplitude equal to or smaller than 60 mA to the mass filter, and the wave-detection unit may have the three rectifiers electrically connected in parallel.

In this case, the overall linearity in the wave-detection unit can be optimized in the range in which the mass-to-charge ratio corresponds to the wave-detection current having a half amplitude equal to or smaller than 60 mA.

(Item 6) The mass spectrometer according to any one of items 1 to 4, wherein the power supply device may apply an AC voltage corresponding to a mass-to-charge equal to or smaller than 2000 to the mass filter, and the wave-detection unit may have the three rectifiers electrically connected in parallel.

In this case, the overall linearity in the wave-detection unit can be optimized in the range in which the mass-to-charge ratio is equal to or smaller than 2000.

(Item 7) The mass spectrometer according to any one of items 1 to 4, wherein the wave-detection unit may further include a wave-detection capacitor that converts an AC voltage to be applied to the mass filter into a wave-detection current and guides the wave-detection current to the plurality of rectifiers, the power supply device may apply an AC voltage corresponding to a wave-detection current having a half amplitude equal to or smaller than 45 mA to the mass filter, and the wave-detection unit may have the two rectifiers electrically connected in parallel.

In this case, the overall linearity in the wave-detection unit can be optimized in the range in which the mass-to-charge ratio corresponds to the wave-detection current having a half amplitude equal to or smaller than 45 mA.

(Item 8) The mass spectrometer according to any one of items 1 to 4, wherein the power supply device may apply an AC voltage corresponding to a mass-to-charge ratio equal to or smaller than 1500 to the mass filter, and the wave-detection unit may have the two rectifiers electrically connected in parallel.

In this case, the overall linearity in the wave-detection unit can be optimized in the range in which the mass-to-charge ratio is equal to or smaller than 1500.

(Item 9) A wave-detection unit according to another aspect detects an AC voltage to be applied to a mass filter that selects ions having a specific mass-to-charge ratio, and has a plurality of rectifiers respectively including rectifying devices, wherein the plurality of rectifiers are electrically connected in parallel.

With the wave-detection unit, even in a case in which the linear operation range of the rectifying device of each rectifier is not so wide, the overall linearity in the wave-detection unit is improved. Therefore, the mass resolution by the mass filter is uniform in the wide range of mass-to-charge ratio. Thus, it is possible to prevent a mass deviation caused by non-linearity of the rectifying devices.

1. A mass spectrometer comprising:
a mass filter that selects ions having a mass-to-charge ratio corresponding to an applied AC voltage;
a wave-detection unit that detects an AC voltage to be applied to the mass filter; and
a power supply device that applies an AC voltage to the mass filter based on an AC voltage detected by the wave-detection unit, wherein
the wave-detection unit has a plurality of rectifiers respectively including rectifying devices, and
the plurality of rectifiers are electrically connected to one another in parallel.

2. The mass spectrometer according to claim 1, wherein
each of the plurality of rectifiers includes a first rectifying device, a second rectifying device, a third rectifying device and a fourth rectifying device, and includes a first node, a second node, a third node and a fourth node, and
in each of the plurality of rectifiers,
a cathode and an anode of the first rectifying device are connected to the first node and the third node, respectively,
a cathode and an anode of the second rectifying device are connected to the second node and the third node, respectively,
a cathode and an anode of the third rectifying device are connected to the fourth node and the first node, respectively,
a cathode and an anode of the fourth rectifying device are connected to the fourth node and the second node, respectively,
the first nodes of the plurality of rectifiers are connected to one another and are used for input of an AC voltage to be applied to the mass filter,
the second nodes of the plurality of rectifiers are connected to one another and are used for input of an AC voltage to be applied to the mass filter,
the third nodes of the plurality of rectifiers are connected to one another,
the fourth nodes of the plurality of rectifiers are connected to one another,
one of the third node and the fourth node is maintained at a ground potential, and
another one of the third node and the fourth node is used for output of a detected AC voltage.

3. The mass spectrometer according to claim 1, wherein
a count of the rectifiers in the wave-detection unit is defined such that a leakage voltage flowing through the rectifying devices maintains linearity in a specific range of mass-to-charge ratio.

4. The mass spectrometer according to claim 3, wherein
a count of the rectifiers in the wave-detection unit is defined such that a leakage voltage flowing through the rectifying devices are at a minimum.

5. The mass spectrometer according to claim 1, wherein
the wave-detection unit further includes a wave-detection capacitor that converts an AC voltage to be applied to the mass filter into a wave-detection current and guides the wave-detection current to the plurality of rectifiers,
the power supply device applies an AC voltage corresponding to a wave-detection current having a half amplitude equal to or smaller than 60 mA to the mass filter, and
the wave-detection unit has the three rectifiers electrically connected in parallel.

6. The mass spectrometer according to claim 1, wherein
the power supply device applies an AC voltage corresponding to a mass-to-charge equal to or smaller than 2000 to the mass filter, and
the wave-detection unit has the three rectifiers electrically connected in parallel.

7. The mass spectrometer according to claim 1, wherein
the wave-detection unit further includes a wave-detection capacitor that converts an AC voltage to be applied to the mass filter into a wave-detection current and guides the wave-detection current to the plurality of rectifiers,
the power supply device applies an AC voltage corresponding to a wave-detection current having a half amplitude equal to or smaller than 45 mA to the mass filter, and
the wave-detection unit has the two rectifiers electrically connected in parallel.

8. The mass spectrometer according to claim 1, wherein
the power supply device applies an AC voltage corresponding to a mass-to-charge ratio equal to or smaller than 1500 to the mass filter, and
the wave-detection unit has the two rectifiers electrically connected in parallel.

9. A wave-detection unit that detects an AC voltage to be applied to a mass filter that selects ions having a specific mass-to-charge ratio, having a plurality of rectifiers respectively including rectifying devices, wherein
the plurality of rectifiers are electrically connected in parallel.
